(19) United States
(12) Patent Application Publication
(10) Pub. No.: US 2016/0112701 A1
(43) Pub. Date: Apr. 21, 2016

(54) VIDEO PROCESSING METHOD, DEVICE AND SYSTEM

(71) Applicant: Tencent Technology (Shenzhen) Company Limited, Shenzhen (CN)

(72) Inventors: Dai Chao, Shenzhen (CN); Lyu Jing, Shenzhen (CN); Chen Wei, Shenzhen (CN); Tang Cheng Zhou, Shenzhen (CN); Wang Rong Gang, Shenzhen (CN)

(73) Assignee: Tencent Technology (Shenzhen) Company Limited

(21) Appl. No.: 14/982,959

(22) Filed: Dec. 29, 2015

Related U.S. Application Data
(63) Continuation of application No. PCT/CN2014/093127, filed on Dec. 5, 2014.

(30) Foreign Application Priority Data
Mar. 25, 2014 (CN) 201410115045.3

(51) Int. Cl. H04N 17/00; G06T 7/20; H04N 5/232

(52) U.S. Cl. CPC H04N 17/002; H04N 5/23258; H04N 5/23229; G06T 7/20; G06T 2207/10016

(57) ABSTRACT

The present disclosure discloses a video processing method, device and system. The method includes: calibrating a video camera equipment using a gyroscope based on a Rodrigues' Rotation Matrix to obtain a calibration parameter; obtaining first video information and first gyroscope rotation information, wherein the first gyroscope rotation information is corresponding to the first video information; performing at least one step of: stabilizing the first video information according to the calibration parameter and the first gyroscope rotation information; and removing rolling shutter effect from the first video information according to the calibration parameter and the first gyroscope rotation information.

### CROSS-REFERENCE TO RELATED APPLICATIONS

This application is a continuation of International Application No. PCT/CN2014/093127, filed on Dec. 5, 2014, which claims priority to Chinese Patent Application No. 201410115045.3, filed on Mar. 25, 2014, which is incorporated by reference in its entirety.

### FIELD OF THE TECHNOLOGY

The present disclosure relates to communication technology field, and more particularly to a video processing method, device and system.

### BACKGROUND OF THE TECHNOLOGY

In order to obtain high-definition videos, the stabilization on the videos needs to be performed. In the video stabilization system and the relevant video processing applications, most inter frame motion estimation methods use image-based feature matching method to perform global motion estimation. For example, the method firstly finds the corresponding relation of a series of points between two frames through feature matching, then uses a global motion model to fit the corresponding relation of these points. Thus the global motion model describing the global motion of two frames may be obtained.

### SUMMARY OF THE TECHNOLOGY

The examples of the present disclosure provide a video processing method, device and system, which improve robustness and lower the computational complexity so that the video may be better processed by using less computational sources. The video quality may be improved.

One example of the present disclosure provides a video processing method. The method includes:

Calibrating a video camera equipment using a gyroscope based on a Rodrigues' Rotation Matrix to obtain a calibration parameter; obtaining first video information and first gyroscope rotation information, wherein the first gyroscope rotation information is corresponding to the first video information; performing at least one of:

Stabilizing the first video information according to the calibration parameter and the first gyroscope rotation information; and removing rolling shutter effect from the first video information according to the calibration parameter and the first gyroscope rotation information.

Accordingly, another example of the present disclosure provides a video processing device. The device includes:

A calibrating unit for calibrating a video camera equipment using a gyroscope based on a Rodrigues' Rotation Matrix to obtain a calibration parameter;

An information obtaining unit for obtaining the first video information and the first gyroscope rotation information, wherein the first gyroscope rotation information is corresponding to the first video information;

A processing unit for performing at least one of: stabilizing the first video information according to the calibration parameter and the first gyroscope rotation information; and removing rolling shutter effect from the first video information according to the calibration parameter and the first gyroscope rotation information.

Accordingly, one example of the present disclosure can also provide a video processing system. The system includes a video processing device having a processor, computer readable medium comprising instructions which, when executed by the processor cause the video processing device to:

Calibrate a video camera equipment using a gyroscope based on a Rodrigues' Rotation Matrix to obtain a calibration parameter;

Obtain first video information and first gyroscope rotation information, wherein the first gyroscope rotation information is corresponding to the first video information;

Perform at least one of steps to: stabilize the first video information according to the calibration parameter and the first gyroscope rotation information; and remove rolling shutter effect from the first video information according to the calibration parameter and the first gyroscope rotation information.

### BRIEF DESCRIPTION OF THE DRAWINGS

To describe the technical solutions in the examples of the present disclosure more clearly, the following briefly introduces the accompanying drawings needed for describing the examples or the prior art. Apparently, the accompanying drawings in the following description show some examples of the present disclosure, and persons of ordinary skill in the art can still derive other drawings from these accompanying drawings without creative efforts.

The system and/or method may be better understood with reference to the following drawings and description. Non-limiting and non-exhaustive descriptions are described with reference to the following drawings. The components in the FIG.s are not necessarily to scale, emphasis instead being placed upon illustrating principles. In the FIG.s, like referenced numerals may refer to like parts throughout the different FIG.s unless otherwise specified.

FIG. 1 is a flowchart of the video processing method according to one example of the present disclosure;

FIG. 2 is a flowchart of the video processing method according to another example of the present disclosure;

FIG. 3 is a flowchart of the video processing method according to another example of the present disclosure;

FIG. 4 is a flowchart of the video processing method according to other example of the present disclosure;

FIG. 5 is a structural schematic diagram of the video processing device according to one example of the present disclosure;

FIG. 6 is a structural schematic diagram of the mobile terminal according to one example of the present disclosure.

### DETAILED DESCRIPTION

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one example,” “an example,” “examples,” “one embodiment,” “an embodiment,” “example embodiment,” or the like in the singular or plural means that one or more particular features, structures, or characteristics described in connection with an embodiment or an example is included in at least one embodiment or one example of the present disclosure. Thus, the appearances of the phrases “in one embodiment,” “in an embodiment,” “in an example embodiment,” “in one example,” “in an example,” or the like in the singular or plural in various places throughout this specification are not necessarily all referring to the same embodiment. Furthermore, the particular features, structures, or characteristics may be combined in any suitable manner in one or more embodiments or examples.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the terms “module,” “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a terminal device, and a communication network. The server and the terminal device may be coupled through the communication network for information exchange, such as sending/receiving identification information, sending/receiving data files such as splash screen images, etc. Although only one terminal device and one server are shown in the environment, any number of terminals or servers may be included, and other devices may also be included.

The communication network may include any appropriate type of communication network for providing network connections to the server and terminal device or among multiple servers or terminal devices. For example, communication network may include the Internet or other types of computer networks or telecommunication networks, either wired or wireless. In a certain embodiment, the disclosed methods and apparatus may be implemented, for example, in a wireless network that includes at least one terminal device.

In some cases, the terminal device or the device may refer to any appropriate user terminal with certain computing capabilities, such as a personal computer (PC), a work station computer, a server computer, a hand-held computing device (tablet), a smart phone or mobile phone, or any other user-side computing device. In various embodiments, the terminal device may include a network access device. The terminal device may be stationary or mobile.

A server, as used herein, may refer to one or more server computers configured to provide certain server functionalities, such as database management and search engines. A server may also include one or more processors to execute computer programs in parallel.

It should be noticed that, the embodiments/examples and the features in the embodiments/examples may be combined with each other in a no conflict condition. This invention will become apparent from the following detailed description when taken in conjunction with the accompanying drawings.

It should be noticed that, the steps illustrated in the flowchart of the drawings may be performed in a set of computer device with executable program codes. And the order of the steps may be different from that in the drawings under some status, although a logic order is shown in the flowchart.

The purpose, technical proposal and advantages in the examples of the present disclosure will become more clear and complete from the following detailed description when taken in conjunction with the appended drawings. Apparently, the examples described thereinafter are merely a part of examples of the present disclosure, not all examples. Persons skilled in the art can obtain all other examples without creative works, based on these examples, which pertains to the protection scope of the present disclosure.

The present disclosure discovers that the existing video processing methods lack robustness, because those existing video processing methods need reliable features to match in the frames of some videos and those reliable features are hard to obtain. Therefore, the processed video has a bad quality. Also, the existing methods require high computational complexity and need a lot of calculating sources. Also, the existing methods may not apply to mobile terminals, such as the platforms with limited calculating ability like mobile phones. The present disclosure discloses a method, device and system to address those problems.

The example of the present disclosure provides a video processing method, device and system, which will be respectively described as follows.

### The First Example

The example of the present disclosure will be described from the angle of video processing device, which may be integrated in the video camera equipment with a gyroscope, this video camera equipment may be a mobile terminal, such as a mobile telephone, a tablet computer, a camera or a video camera.

The first example provides a video processing method, which includes: calibrating a video camera equipment using a gyroscope based on a Rodrigues' Rotation Matrix to obtain a calibration parameter; obtaining first video information and first gyroscope rotation information, wherein the first gyroscope rotation information is corresponding to the first video information; performing stabilization on the first video information according to the calibration parameter and the first gyroscope rotation information.

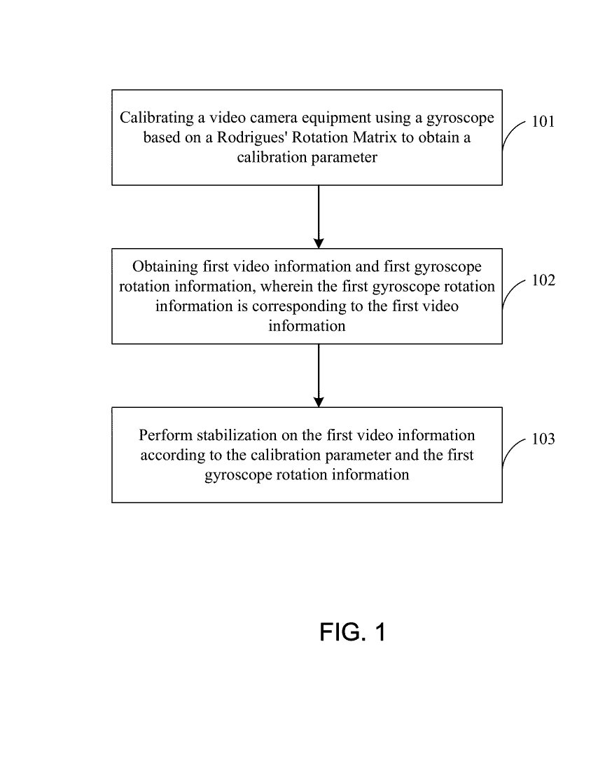

As shown in FIG. 1, the steps of this video processing method are as follows:

101. calibrating a video camera equipment using a gyroscope based on a Rodrigues' Rotation Matrix to obtain a calibration parameter, for example, the following method may be used to calibrate the video camera equipment.

(1) obtaining a gyroscope rotation angular velocity of the video camera equipment; for example, the gyroscope rotation angular velocity may be read out from the gyroscope.

(2) modeling the gyroscope rotation angular velocity with the Rodrigues' Rotation Matrix to obtain a motion model of the Rodrigues' Rotation Matrix, for example, this step may be as follows:

Obtaining rotation time corresponding to the gyroscope rotation angular velocity; combining the gyroscope rotation angular velocity and the rotation time, and constructing a rotation matrix according to the Rodrigues' Rotation Matrix to obtain the motion model of the Rodrigues' Rotation Matrix.

(3) obtaining second video information and the corresponding gyroscope rotation information, in order to facilitate description, in the present disclosure, the gyroscope rotation information which is corresponding to the second video information is called the second gyroscope rotation information.

For example, the video information may be obtained by shooting video, in order to facilitate description, in this example, the video information obtained during modeling is called the second video information.

And the gyroscope rotation information in the example includes gyroscope rotation angular velocity and/or the corresponding rotation time, etc.

(4) combining the second video information with the second gyroscope rotation information to calibrate the video camera equipment based on the motion model of the Rodrigues' Rotation Matrix to obtain the calibration parameter. For example, the details of this step are as follows:

A. detecting feature points preset in each frame of the second video information, matching the feature points between two adjacent frames and obtaining a feature matching relationship;

B. switching the second gyroscope rotation information based on the motion model of the Rodrigues' Rotation Matrix, and obtaining a corresponding three-dimensional rotation matrix;

C. calibrating the video camera equipment according to the three-dimensional rotation matrix and the feature matching relationship to obtain the calibration parameter.

For example, fitting the feature matching relationship according to a preset optimization strategy to obtain the fitted feature matching relationship; calculating the calibration parameter of the video camera equipment according to the three-dimensional rotation matrix obtained in step B and the fitted feature matching relationship.

The calibration parameters may include internal parameters of video camera equipment, frame capturing time, and deviation between gyroscope timestamp and frame timestamp of video information. And the optimization strategy may be set according to the needs in the practical application.

It needs to be mentioned that one of the basic tasks of computer vision is calculating the geometrical information of the objects in three-dimensional space according to the image information obtained by the camera, and then reconstructing and recognizing the objects, the relationship between the three-dimensional geometrical location of some points on a space object surface and its corresponding points in the image is decided by the imaging geometrical model of the camera, these geometrical model parameters are camera parameters, which are calibration parameters in this example.

In most conditions, these parameters must be obtained by experiments and calculating, this process is called camera calibration, that is to say the calibration process is to determine the geometrical and optical parameters as well as the orientation of the camera relative to the world coordinate system. The calibration precision directly affects the precision of the computer vision (machine vision).

102. obtaining the first video information and the corresponding gyroscope rotation information, in order to facilitate description, in this example, the gyroscope rotation information corresponding to the first video information is called the first gyroscope rotation information.

For example, the video information may be obtained by shooting video, in order to facilitate the description, in this example, the video information which needs to be performed stabilization on and/or corrected (such as removing rolling shutter effect) is called the first video information.

103. performing stabilization on the first video information according to the calibration parameter(s) and the first gyroscope rotation information, for example, the steps of this method are as follows:

(1) making the first gyroscope rotation information smoothed and obtaining accumulated product of the first rotation angular velocity;

(2) determining the frame to be processed according to the first video information;

(3) obtaining gyroscope rotation angular velocity corresponding to each frame between the first frame of the first video information and the frame to be processed from the first gyroscope rotation information;

(4) calculating accumulated product of the second rotation angular velocity according to gyroscope rotation angular velocity corresponding to each frame, wherein the accumulated product of the second rotation angular velocity is the accumulated product of the rotation angular velocity from the first frame of the first video information to the frame to be processed;

(5) calculating a difference between the accumulated product of the second rotation angular velocity and the accumulated product of the first rotation angular velocity and obtaining the first difference;

(6) obtaining first global motion matrix according to the first difference and the calibration parameters;

(7) re-rendering the first video information according to the first global motion matrix, thus achieving the purpose of stabilization.

Moreover, besides stabilization process, in order to further improve the video quality, the first video information may be performed correction process on, such as removing the rolling shutter effect. That is to say after obtaining the first video information and the first gyroscope rotation information, the video processing method can also include: removing rolling shutter effect of the first video information according to the calibration parameters and the first gyroscope rotation information. For example, the steps may be as follows:

Determining the frame to be processed according to the first video information; obtaining the gyroscope rotation angular velocity corresponding to the frame to be processed from the first gyroscope rotation information; obtaining a rotation angular velocity of a first line of the frame to be processed and a rotation angular velocity of a Nₜₕ line of the frame to be processed according to the gyroscope rotation angular velocity corresponding to the frame to be processed; calculating the difference between the rotation angular velocity of the first line and the rotation angular velocity of the Nₜₕ line to obtain a second difference; obtaining a second global motion matrix according to the second difference and the calibration parameter(s); re-rendering the first video information according to the second global motion matrix, wherein N is a positive integer, which may be set according to the needs in the practical application.

The technical solutions provided by the examples of the present disclosure can calibrate the video camera equipment with a gyroscope based on Rodrigues' Rotation Matrix and obtain calibration parameter; then obtain the first video information and the first gyroscope rotation information, perform stabilization on the first video information according to the calibration parameters and the first gyroscope rotation information and/or remove rolling shutter effect of the first video information according to the calibration parameters and the first gyroscope rotation information so as to correct the video.

This solution uses Rodrigues' Rotation Matrix instead of other rotation matrixes, thus it may be more precise when calculating the calibration parameters, and the computational complexity may be very low, that is to say by using this solution, the robustness may be improved, and the computational complexity is low so that the video may be better processed without using many computational sources and the video quality may be improved.

### The Second Example

Furthermore, this example provides another video processing method, like the first example, the example of the present disclosure will be described from the angle of the video processing device, which may be integrated in the video camera equipment with a gyroscope, this video camera equipment may be a mobile terminal, such as a mobile telephone, a tablet computer, a camera or a video camera.

The second example provides a video processing method, which comprises: calibrating the video camera equipment with a gyroscope based on Rodrigues' Rotation Matrix and obtaining calibration parameters; obtaining the first video information and the corresponding gyroscope rotation information (the first gyroscope rotation information); removing rolling shutter effect of the first video information according to the calibration parameters and the first gyroscope rotation information.

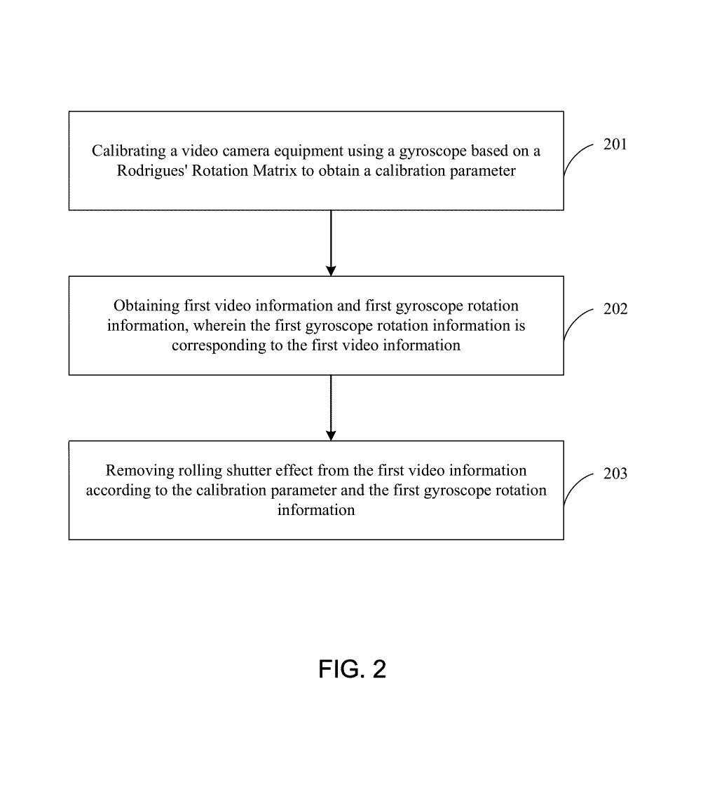

As shown in FIG. 2, the steps of this video processing method are as follows:

201. calibrating a video camera equipment using a gyroscope based on a Rodrigues' Rotation Matrix to obtain a calibration parameter or parameters, for example, the following method may be used to calibrate the video camera equipment.

(1) obtaining gyroscope rotation angular velocity of the video camera equipment; for example, the gyroscope rotation angular velocity may be read out from the gyroscope.

(2) modeling the gyroscope rotation angular velocity with Rodrigues' Rotation Matrix and obtaining a motion model of Rodrigues' Rotation Matrix, for example, this step may be as follows: obtaining rotation time corresponding to the gyroscope rotation angular velocity; combining the gyroscope rotation angular velocity and the rotation time, constructing rotation matrix according to the form of Rodrigues' Rotation Matrix and obtaining the motion model of Rodrigues' Rotation Matrix.

(3) obtaining the second video information and the corresponding gyroscope rotation information i.e. the second gyroscope rotation information.

For example, the video information may be obtained by shooting video, in order to facilitate description, in this example; the video information obtained during modeling is called the second video information.

(4) calibrating the video camera equipment according to the second video information and the second gyroscope rotation information based on the motion model of Rodrigues' Rotation Matrix and obtaining calibration parameters. For example, the details of this step are as follows:

A. detecting feature points preset in each frame of the second video information, matching feature points between two adjacent frames and obtaining feature matching relationship;

B. switching the second gyroscope rotation information based on the motion model of Rodrigues' Rotation Matrix, and obtaining the corresponding three-dimensional rotation matrix;

C. calibrating the video camera equipment according to the three-dimensional rotation matrix and feature matching relationship, obtaining calibration parameters.

For example, fitting the feature matching relationship according to the preset optimization strategy and obtain the fitted feature matching relationship; calculating the calibration parameters of the video camera equipment with the three-dimensional rotation matrix obtained in step B and the fitted feature matching relationship.

The calibration parameters may include internal parameters of video camera equipment, frame capturing time, and deviation between gyroscope timestamp and frame timestamp of video information.

202. obtaining the first video information and the corresponding gyroscope rotation information i.e. the first gyroscope rotation information.

For example, the video information may be obtained by shooting video, in order to facilitate the description, in this example, the video information which needs to be performed stabilization on and/or corrected is called the first video information.

203. removing rolling shutter effect from the first video information according to the calibration parameter and the first gyroscope rotation information. For example, the steps may be as follows:

Determining the frame to be processed according to the first video information; obtaining gyroscope rotation angular velocity corresponding to the frame to be processed from the first gyroscope rotation information; obtaining rotation angular velocity of the first line of the frame to be processed and rotation angular velocity of the Nₜₕ line of the frame to be processed according to gyroscope rotation angular velocity corresponding to the frame to be processed; calculating the difference between the rotation angular velocity of the first line and the rotation angular velocity of the Nₜₕ line and obtaining the second difference; obtaining second global motion matrix according to the second difference and the calibration parameters; re-rendering the first video information according to the second global motion matrix, thus achieving the purpose of removing rolling shutter effect, wherein N is a positive integer, which may be set according to the needs in the practical application.

Moreover, the first video information may be performed stabilization on, and the details are recorded in the first example, which are not repeated here.

The technical solutions provided by the examples of the present disclosure can calibrate the video camera equipment with a gyroscope based on Rodrigues' Rotation Matrix and obtain calibration parameters; then obtain the first video information and the first gyroscope rotation information, remove rolling shutter effect of the first video information according to the calibration parameters and the first gyroscope rotation information so as to correct the video.

This solution uses Rodrigues' Rotation Matrix instead of other rotation matrixes, thus it may be more precise when calculating the calibration parameters, and the computational complexity may be very low, that is to say by using this solution, the robustness may be improved, and the computational complexity is low so that the video may be better processed without occupying many computational sources and the video quality may be improved.

According to the methods described in the first and second example, the third, fourth and fifth example will give some examples to further illustrate this video processing method.

### The Third Example

In this example, the following example will be given, wherein the video processing device is integrated in the video camera equipment with a gyroscope, and the video camera equipment is a mobile terminal.

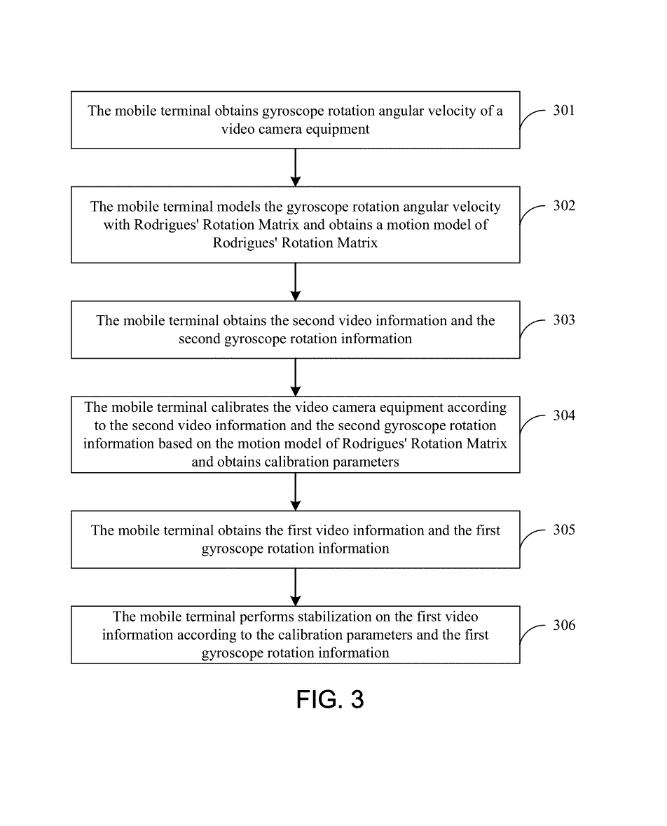

As shown in FIG. 3, the third example provides a video processing method, the steps are as follows:

301. The mobile terminal obtains gyroscope rotation angular velocity of a video camera equipment; for example, the gyroscope rotation angular velocity may be obtained from the gyroscope of a mobile terminal.

302. The mobile terminal models the gyroscope rotation angular velocity with Rodrigues' Rotation Matrix and obtains a motion model of Rodrigues' Rotation Matrix, for example, this step may be as follows:

The mobile terminal obtains rotation time corresponding to the gyroscope rotation angular velocity; combines the gyroscope rotation angular velocity and the rotation time, constructs rotation matrix according to the form of Rodrigues' Rotation Matrix and obtains the motion model of Rodrigues' Rotation Matrix.

303. The mobile terminal obtains the second video information and the corresponding gyroscope rotation information i.e. the second gyroscope rotation information.

For example, choose a distant building, rotate the mobile device, shoot a video, obtain the second video information, record the gyroscope rotation information read out from gyroscope, which means to obtain the second gyroscope rotation information. The mobile device may be arbitrarily moved to shoot anything.

304. The mobile terminal calibrates the video camera equipment according to the second video information and the second gyroscope rotation information based on the motion model of Rodrigues' Rotation Matrix and obtains calibration parameters. For example, the details of this step are as follows:

(1). The mobile terminal detects feature points preset in each frame of the second video information, matches feature points between two adjacent frames and obtains feature matching relationship.

For example, the Scale-invariant feature transform (SIFT) algorithm may be used to detect feature points, and the feature matching method based on K-dimension tree (KD) may be used to match feature points. Usually, there are about 400 SIFT feature points to be detected in each frame.

It needs to be mentioned that other algorithms may also be used to perform feature points detecting and matching, which is not provided here.

(2) The mobile terminal switches the second gyroscope rotation information based on the motion model of Rodrigues' Rotation Matrix, and obtains the corresponding three-dimensional rotation matrix.

(3) The mobile terminal calibrates the video camera equipment according to the three-dimensional rotation matrix and feature matching relationship, obtains calibration parameters.

For example, the mobile terminal may fit the feature matching relationship according to the preset optimization strategy and obtain the fitted feature matching relationship; calculate the calibration parameters of the video camera equipment with the three-dimensional rotation matrix obtained in step (1) and the fitted feature matching relationship.

The calibration parameters may include internal parameters of video camera equipment, frame capturing time, and deviation between gyroscope timestamp and frame timestamp of video information. And the optimization strategy may be set according to the needs in the practical application.

305. The mobile terminal obtains the first video information and the corresponding gyroscope rotation information i.e. the first gyroscope rotation information.

The video information may be obtained by shooting video, for example, choosing a distant building, rotating the mobile device, shooting a video, obtaining the second video information, recording the gyroscope rotation information reading out from gyroscope, which means to obtain the second gyroscope rotation information. The mobile device may be arbitrarily moved to shoot anything.

306. The mobile terminal performs stabilization on the first video information according to the calibration parameters and the first gyroscope rotation information, for example, the steps of this method are as follows:

(1) the mobile terminal makes the first gyroscope rotation information smoothed and obtains accumulated product of the first rotation angular velocity;

For example, the mobile terminal may use Gaussian kernel of which the standard deviation is 32 and the radius is 20 to make the rotation angular velocity smoothed. Other methods may be adopted, which is not provided here.

(2) the mobile terminal determines the frame to be processed according to the first video information;

(3) the mobile terminal obtains gyroscope rotation angular velocity corresponding to each frame between the first frame of the first video information and the frame to be processed from the first gyroscope rotation information;

(4) the mobile terminal calculates accumulated product of the second rotation angular velocity according to gyroscope rotation angular velocity corresponding to each frame, wherein the accumulated product of the second rotation angular velocity is accumulated product of the rotation angular velocity from the first frame of the first video information to the frame to be processed;

(5) the mobile terminal calculates difference between the accumulated product of the second rotation angular velocity and the accumulated product of the first rotation angular velocity and obtains the first difference;

(6) the mobile terminal obtains first global motion matrix according to the first difference and the calibration parameters;

(7) the mobile terminal re-renders the first video information according to the first global motion matrix

After performing the operation mentioned in step 306 on each frame, the stabilization effect may be achieved.

The mobile terminal in this example of the present disclosure can calibrate the video camera equipment based on Rodrigues' Rotation Matrix and obtain calibration parameters; then obtain the first video information and the first gyroscope rotation information, perform stabilization on the first video information according to the calibration parameter and the first gyroscope rotation information. This solution uses Rodrigues' Rotation Matrix instead of other rotation matrixes, it may be more precise when calculating the calibration parameters, and the computational complexity may be very low. By using this solution, the robustness may be improved, and the computational complexity is low so that the video may be better processed without using many computational sources and the video quality may be improved.

### The Fourth Example

In this example, the video processing device is integrated in the video camera equipment with a gyroscope, the video camera equipment is a mobile terminal, and the first video information will be corrected.

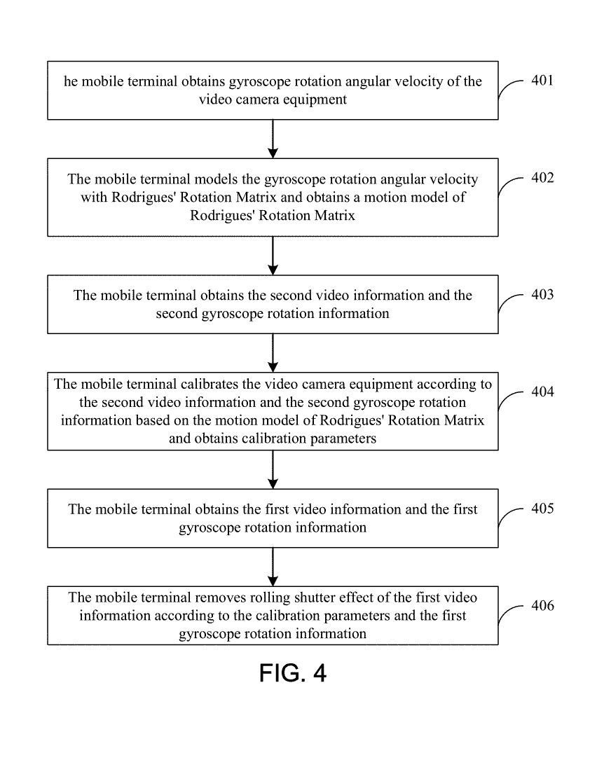

As shown in FIG. 4, the fourth example provides a video processing method, the steps are as follows:

401. The mobile terminal obtains gyroscope rotation angular velocity of the video camera equipment; for example, the gyroscope rotation angular velocity may be read out from the gyroscope of the mobile terminal.

402. The mobile terminal models the gyroscope rotation angular velocity with Rodrigues' Rotation Matrix and obtains a motion model of Rodrigues' Rotation Matrix, for example, this step may be as follows:

The mobile terminal obtains rotation time corresponding to the gyroscope rotation angular velocity; combines the gyroscope rotation angular velocity and the rotation time, constructs rotation matrix according to the form of Rodrigues' Rotation Matrix and obtains the motion model of Rodrigues' Rotation Matrix.

403. The mobile terminal obtains the second video information and the corresponding gyroscope rotation information i.e. the second gyroscope rotation information.

For example, the mobile terminal may choose a distant building, rotate the mobile device, shoot a video, obtain the second video information, record the gyroscope rotation information read out from gyroscope, which means to obtain the second gyroscope rotation information. The mobile device may be arbitrarily moved to shoot anything.

404. The mobile terminal calibrates the video camera equipment according to the second video information and the second gyroscope rotation information based on the motion model of Rodrigues' Rotation Matrix and obtains calibration parameters. For example, the details of this step are as follows:

(1). The mobile terminal detects feature points preset in each frame of the second video information, matches feature points between two adjacent frames and obtains feature matching relationship.

For example, the Scale-invariant feature transform (SIFT) algorithm may be used to detect feature points, and the feature matching method based on K-dimension tree (KD) may be used to match feature points. Usually, there are about 400 SIFT feature points to be detected in each frame.

It needs to be mentioned that other algorithms may be used to perform feature points detecting and matching, which are not provided here.

(2) The mobile terminal switches the second gyroscope rotation information based on the motion model of Rodrigues' Rotation Matrix, and obtains the corresponding three-dimensional rotation matrix.

(3) The mobile terminal calibrates the video camera equipment according to the three-dimensional rotation matrix and feature matching relationship, obtains calibration parameters.

For example, the mobile terminal may fit the feature matching relationship according to the preset optimization strategy and obtain the fitted feature matching relationship; calculate the calibration parameters of the video camera equipment with the three-dimensional rotation matrix obtained in step (1) and the fitted feature matching relationship.

The calibration parameters may include internal parameters of the video camera equipment, frame capturing time, and deviation between gyroscope timestamp and frame timestamp of video information. And the optimization strategy may be set according to the needs in the practical application.

405. The mobile terminal obtains the first video information and the corresponding gyroscope rotation information i.e. the first gyroscope rotation information.

The video information may be obtained by shooting video, for example, choosing a distant building, rotating the mobile device, shooting a video, obtaining the second video information, recording the gyroscope rotation information reading out from gyroscope, which means to obtain the second gyroscope rotation information. The mobile device may be arbitrarily moved to shoot anything.

406. The mobile terminal removes rolling shutter effect of the first video information according to the calibration parameters and the first gyroscope rotation information so as to correct the first video. For example, the steps may be as follows:

(1) the terminal determines the frame to be processed according to the first video information;

(2) the terminal obtains gyroscope rotation angular velocity corresponding to the frame to be processed from the first gyroscope rotation information;

(3) the terminal obtains rotation angular velocity of the first line of the frame to be processed and rotation angular velocity of the Nₜₕ line of the frame to be processed according to gyroscope rotation angular velocity corresponding to the frame to be processed;

(4) the terminal calculates the difference between the rotation angular velocity of the first line and the rotation angular velocity of the Nₜₕ line and obtains the second difference;

(5) the terminal obtains second global motion matrix according to the second difference and the calibration parameters;

(6) the terminal re-renders the first video information according to the second global motion matrix, thus achieving the purpose of removing rolling shutter effect, wherein N is a positive integer, which may be set according to the needs in the practical application.

It may be seen that the mobile terminal in the example of the present disclosure can calibrate the video camera equipment with gyroscope based on Rodrigues' Rotation Matrix and obtain calibration parameters; then obtain the first video information and the first gyroscope rotation information, remove rolling shutter effect of the first video information according to the calibration parameters and the first gyroscope rotation information so as to correct the video.

This solution uses Rodrigues' Rotation Matrix instead of other rotation matrixes, thus it may be more precise when calculating the calibration parameters, and the computational complexity may be very low, that is to say by using this solution, the robustness may be improved, and the computational complexity is low so that the video may be better processed without using many computational sources and the video quality may be improved.

### The Fifth Example

In order to further improve the video quality, except for the stabilization process mentioned in the third example and the rolling shutter effect removing process mentioned in the fourth example, the video information may be performed these two processes on at the same time, which means to combine the third and fourth example, the specific steps are recorded in the third and fourth example, besides, the stabilization process and rolling shutter effect removing process may be performed in any order.

This example can achieve the benefits mentioned in the third and fourth example at the same time, which needs not to be repeated here.

### The Sixth Example

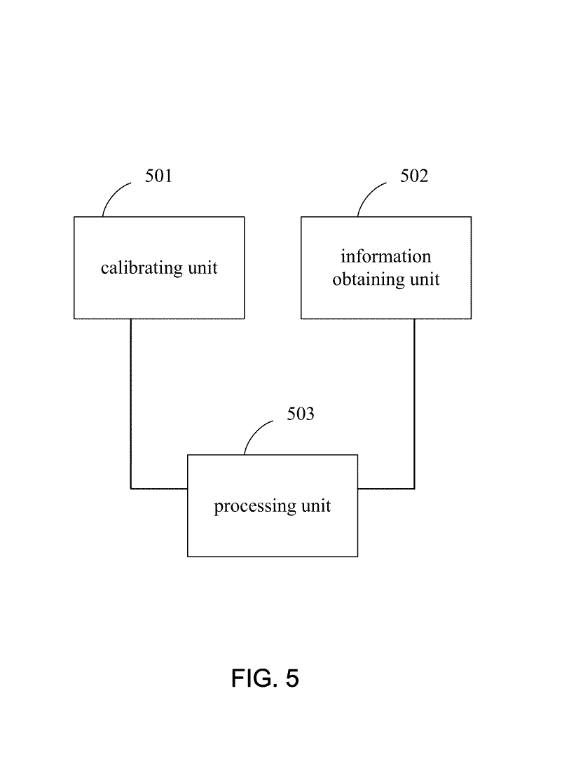

Accordingly, the example in this disclosure may also provide a video processing device, as shown in FIG. 5, this video processing device includes a calibrating unit 501, an information obtaining unit 502 and a processing unit 503.

The calibrating unit 501 may be used for calibrating the video camera equipment with gyroscope based on Rodrigues' Rotation Matrix and obtaining calibration parameter(s).

The information obtaining unit 502 may be used for obtaining the first vide information and the first gyroscope rotation information, wherein the first gyroscope rotation information is corresponding to the first video information.

The processing unit 503 may be used for performing stabilization on the first video information according to the calibration parameters obtained by the calibrating unit 501 and the first gyroscope rotation information obtained by the information obtaining unit 502 and/or removing rolling shutter effect of the first video information according to the calibration parameters and the first gyroscope rotation information.

The calibrating unit 501 comprises an obtaining subunit, a modeling subunit and a calibrating subunit.

The obtaining subunit may be used for obtaining gyroscope rotation angular velocity of the video camera equipment and obtaining the second video information and the second gyroscope rotation information, wherein the second gyroscope rotation information is corresponding to the second video information.

For example, the obtaining subunit may read out the gyroscope rotation angular velocity form the gyroscope of the video camera equipment, and obtain the second video information and the second gyroscope rotation information by shooting video and recording the gyroscope rotation information in the same time.

The modeling subunit may be used for modeling the gyroscope rotation angular velocity with Rodrigues' Rotation Matrix and obtaining a motion model of Rodrigues' Rotation Matrix.

For example, the modeling subunit may be used for obtaining rotation time corresponding to the gyroscope rotation angular velocity; combining the gyroscope rotation angular velocity and the rotation time, constructing rotation matrix according to the form of Rodrigues' Rotation Matrix and obtaining the motion model of Rodrigues' Rotation Matrix

The calibrating subunit may be used for combining the second video information and the second gyroscope rotation information to calibrate the video camera equipment based on the motion model of Rodrigues' Rotation Matrix and obtaining calibration parameters.

For example, the calibrating subunit may be used for detecting feature points preset in every frame of the second video information, matching feature points between two adjacent frames and obtaining feature matching relationship; switching the second gyroscope rotation information based on the motion model of Rodrigues' Rotation Matrix, and obtaining the corresponding three-dimensional rotation matrix; then calibrating the video camera equipment according to the three-dimensional rotation matrix and feature matching relationship, obtaining calibration parameters.

The method of calibrating the video camera equipment according to the three-dimensional rotation matrix and feature matching relationship, and obtaining calibration parameters comprises:

fitting the feature matching relationship according to the preset optimization strategy and obtaining fitted feature matching relationship; calculating the calibration parameters of video camera equipment according to the obtained three-dimensional rotation matrix and fitted feature matching relationship.

The calibration parameters may include internal parameters of video camera equipment, frame capturing time, and deviation between gyroscope timestamp and frame timestamp of video information. And the optimization strategy may be set according to the needs in practical application.

The processing unit 503 may comprise a stabilization performing subunit and/or a correction processing subunit, wherein

the stabilization performing subunit may be used for making the first gyroscope rotation information smoothed and obtaining accumulated product of the first rotation angular velocity; determining the frame to be processed according to the first video information; obtaining gyroscope rotation angular velocity corresponding to each frame between the first frame of the first video information and the frame to be processed from the first gyroscope rotation information; calculating accumulated product of the second rotation angular velocity according to gyroscope rotation angular velocity corresponding to the each frame, wherein the accumulated product of the second rotation angular velocity is accumulated product of the rotation angular velocity from the first frame of the first video information to the frame to be processed; calculating difference between the accumulated product of the second rotation angular velocity and the accumulated product of the first rotation angular velocity and obtaining the first difference; obtaining first global motion matrix according to the first difference and the calibration parameters; re-rendering the first video information according to the first global motion matrix;

And the correction processing subunit may be used for determining the frame to be processed according to the first video information; obtaining gyroscope rotation angular velocity corresponding to the frame to be processed from the first gyroscope rotation information; obtaining rotation angular velocity of the first line of the frame to be processed and rotation angular velocity of the Nₜₕ line of the frame to be processed according to gyroscope rotation angular velocity corresponding to the frame to be processed; calculating the difference between the rotation angular velocity of the first line and the rotation angular velocity of the Nₜₕ line and obtaining the second difference; obtaining second global motion matrix according to the second difference and the calibration parameters; re-rendering the first video information according to the second global motion matrix.

N is a positive integer, which may be set according to the needs in the practical application.

When concretely implementing this invention, each unit mentioned above may be implemented as the same entity, or they may be arbitrarily combined as one or a few entities, and the concrete implementation of each unit can refer to the examples mentioned before, which needs not to be repeated here.

The video processing device may be integrated in the video camera equipment with a gyroscope, this video camera equipment may be a mobile terminal, such as a mobile phone, a tablet computer, a laptop, a camera or a video camera.

It may be seen that the calibrating unit 501 of the video processing device can calibrate the video camera equipment with a gyroscope based on Rodrigues' Rotation Matrix and obtain calibration parameters; then the information obtaining unit 502 obtains the first video information and the first gyroscope rotation information, and the processing unit 503 performs stabilization on the first video information according to the calibration parameters and the first gyroscope rotation information and/or removes rolling shutter effect of the first video information according to the calibration parameters and the first gyroscope rotation information.

This solution uses Rodrigues' Rotation Matrix instead of other rotation matrixes, thus it may be more precise when calculating the calibration parameters, and the computational complexity may be very low, that is to say by using this solution, the robustness may be improved, and the computational complexity is low so that the video may be better processed without using many computational sources and the video quality may be improved.

### The Seventh Example

Accordingly, the present disclosure also provides a video processing system, which can include any video processing device provided by the present disclosure, the details are recorded in the sixth example, for example:

The video processing system may be used for calibrating the video camera equipment with gyroscope based on Rodrigues' Rotation Matrix and obtaining calibration parameters; obtaining the first video information and the corresponding gyroscope rotation information (the first gyroscope rotation information); performing stabilization on the first video information according to the calibration parameters and the first gyroscope rotation information;

Or the video processing system may be used for calibrating the video camera equipment with a gyroscope based on Rodrigues' Rotation Matrix and obtaining calibration parameters; obtaining the first video information and the corresponding gyroscope rotation information (the first gyroscope rotation information); removing rolling shutter effect of the first video information according to the calibration parameters and the first gyroscope rotation information;

Or the video processing system may be used for calibrating the video camera equipment with a gyroscope based on Rodrigues' Rotation Matrix and obtaining calibration parameters; obtaining the first video information and the corresponding gyroscope rotation information (the first gyroscope rotation information); performing stabilization on the first video information according to the calibration parameters and the first gyroscope rotation information, and removing rolling shutter effect of the first video information according to the calibration parameters and the first gyroscope rotation information.

As for the concrete operations of the steps in the video processing system, the examples mentioned above may be used to refer to, which needs not to be repeated here.

It may be seen that the video processing system of this example may calibrate the video camera equipment with gyroscope based on Rodrigues' Rotation Matrix and obtain calibration parameter; then obtain the first video information and the first gyroscope rotation information, perform stabilization process on the first video information according to the calibration parameter and the first gyroscope rotation information and/or remove rolling shutter effect on the first video information according to the calibration parameter and the first gyroscope rotation information.

This solution uses Rodrigues' Rotation Matrix, comparing with the solutions which use other rotation matrixes, it may be more precise when calculating the calibration parameters, and the computational complexity may be low, that is to say by using this solution, the robustness may be improved, and the computational complexity is low so that the video may be better processed under the situation of using fewer computational sources and the video quality may be improved.

### The Eighth Example

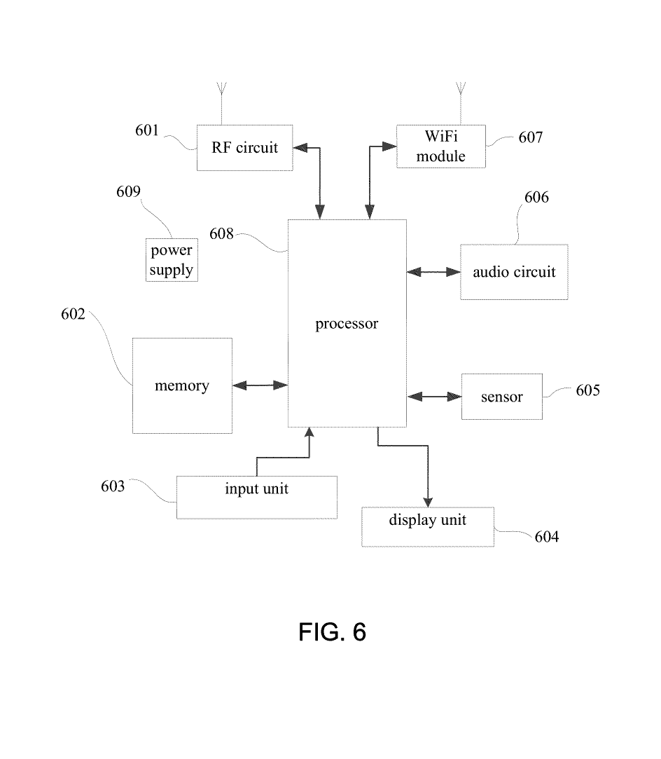

Accordingly, the present disclosure also provides a mobile terminal, which integrates any video processing device provided by the present disclosure, as shown in FIG. 6, this terminal can include a RF circuit 601, a memory 602 which comprises one or more computer readable storage mediums, an input unit 603, a display unit 604, a sensor 605, an audio circuit 606, a WiFi module 607, a processor 608 which comprises one or more processing cores and a power supply 609. Persons skilled in the art can understand that the terminal is not limited by the terminal structures shown in FIG. 6, which may include more or fewer components or combinations of some components or different component layout.

The RF circuit 601 is arranged for receiving and sending signals during calling or process of receiving and sending messages. Specially, the RF circuit 601 may receive downlink information from the base station and send it to the processor 608; or send uplink data to the base station. Generally, the RF circuit 601 includes, but is not limited to, an antenna, at least one amplifier, a transceiver, a coupler, a low noise amplifier (LNA), a diplexer, and the like. In addition, the RF circuit 601 can communicate with network or other devices by wireless communication. Such wireless communication can use any one communication standard or protocol, which includes, but is not limited to, Global System of Mobile communication (GSM), General Packet Radio Service (GPRS), Code Division Multiple Access (CDMA), Wideband Code Division Multiple Access (WCDMA), Long Term Evolution (LTE), email, or Short Messaging Service (SMS).

The memory 602 may be arranged for storing software program and module which will be run by the processor 608, so as to perform multiple functional applications of the mobile phone and data processing. The memory 602 mainly includes storing program area and storing data area. Concretely, the storing program area can store the operating system, at least one application program with required function (such as sound playing function, image playing function, etc.). The storing data area can store data established by mobile phone according to actual using demand (such as audio data, phonebook, etc.) Furthermore, the memory 602 may be high-speed random access memory, or nonvolatile memory, such as disk storage, flash memory device, or other volatile solid-state memory devices. Accordingly, the memory 602 can also include a memory controller so that the process 608 and the input unit 603 can access to the memory 602.

The instructions used for performing the methods disclosed in the present disclosure may be stored in any computer readable medium, either transitory or non-transitory.

The input unit 603 may be used for receiving the input numbers or character information, and generating the keyboard, mouse, operating lever, optical or trackball signal input which is related to user setting and function control. Concretely, in one concrete example, the input unit 603 can include touch sensitive surface and other input devices. The touch sensitive surface, which can also be called touch display screen or touchpad, can collect user's touch operations thereon or nearby (for example the operations generated by fingers of user or touchpen, and the like, touching on the touch sensitive surface or touching near the touch sensitive surface), and drive the corresponding connection device according to the preset program.

Optionally, the touch sensitive surface includes two portions including a touch detection device and a touch controller. Specifically, the touch detection device is arranged for detecting touch position of the user and detecting signals accordingly, and then sending the signals to the touch controller. Subsequently, the touch controller receives touch information from the touch detection device, and converts it to contact coordinates which are to be sent to the processor 608, and then receives command sent by the processor 608 to perform. In addition, besides the touch sensitive surface, the input unit 603 can include, but is not limited to, other input devices, such as one or more selected from physical keyboard, function keys (such as volume control keys, switch key-press, etc.), a trackball, a mouse, and an operating lever, etc.

The display unit 604 may be used for displaying the information input by users or the information provided to users or all kinds of graphic user interfaces, wherein the graphic user interfaces may be composed of graphics, texts, irons, and videos or any combination of these things. Moreover, the display unit 604 includes a display panel, such as a Liquid Crystal Display (LCD), or an Organic Light-Emitting Diode (OLED).

Furthermore, the display panel may be covered by the touch sensitive surface, after touch operations are detected on or near the touch sensitive surface, they will be sent to the processor 608 to determine the type of the touching event. Subsequently, the processor 608 supplies the corresponding visual output to the display panel according to the type of the touching event. As shown in FIG. 6, the touch sensitive surface and the display panel are two individual components to implement input and output of the mobile phone, but they may be integrated together to implement the input and output in some examples.

The terminal can also include at least one kind of sensor 605, such as light sensors, motion sensors, or other sensors. Specifically, the light sensors includes ambient light sensors for adjusting brightness of the display panel according to the ambient light, and proximity sensors for turning off the display panel and/or maintaining backlight when the mobile phone is moved to the ear side.

Accelerometer sensor as one of the motion sensors can detect the magnitude of accelerations in every direction (Triaxial, generally), and detect the magnitude and direction of gravity in an immobile status, which is applicable to applications of identifying attitudes of the mobile (such as switching between horizontal and vertical screens, related games, magnetometer attitude calibration, etc.), vibration recognition related functions (such as pedometer, percussion, etc.). And the terminal also can configure other sensors (such as gyroscopes, barometers, hygrometers, thermometers, infrared sensors, etc.), whose detailed descriptions are omitted here.

The audio circuit 606, loudspeaker, microphone can provide the audio interface between users and the terminal. The audio circuit 606 can send the electronic signal which is converted from the received audio data to the loudspeaker, after receiving the electronic signal, the loudspeaker converts it into the sound signal and outputs the sound signal. On the other hand, the microphone converts the sound signal into the electronic signal, the audio circuit 606 receives the electronic signal, converts it into audio data, and then sends the audio data to the processor 608, after processing the audio data, the processor 608 sends the data to the other terminal via the RF circuit 601 or sends the data to the memory 602. The audio circuit 606 also includes earplug jacks, thus the earphone set outside can communicate with the terminal.

WiFi pertains to a short-range wireless transmission technology providing a wireless broadband Internet, by which the terminal can help the user to receive and send email, browse web, and access streaming media, etc. Although the WiFi module 607 is illustrated in FIG. 6, it should be understood that the WiFi module 607 is not a necessary component of the terminal, which may be omitted according to the actual demand without changing the essence of the present disclosure.

The processor 608 may be a controlling center of the terminal, which uses every interface and line to connect every part of the mobile phone, runs the program and/or module stored in the memory 602 and calls the data in the memory 602 to execute every function of the terminal and process the data so as to monitor the mobile phone. Preferably, the processor 608 can include one or more processing units; the processor 608 can integrate with application processors and modem processors, for example, the application processors include processing operating system, user interface and applications, etc.; the modern processors are used for performing wireless communication. It may be understood that, it's an option to integrate the modern processors to the processor 608.

The terminal may also include the power supply 609 (such as battery) supplying power for each component, preferably, the power supply may be logically connected to the processor 608 through the power supply management system so as to perform recharging management, discharging management and power management. The power supply 609 can include one or more DC powers or AC powers, rechargeable systems, power supply fault detection systems, power converters or inverters, power supply status indicators.

The mobile terminal may also include a camera, Bluetooth modules. Concretely, in this example, the processor 608 in the terminal can load the executable files corresponding to the application programs to the memory 602, thus the processor 608 can run the application program stored in the memory 602 to realize all kinds of function.

Moreover, in this example, the display unit of the terminal may be a touch-screen monitor, and the terminal also includes a memory and one or more programs stored in the memory, configuring one or more processors to run one or more programs which include the instruction to perform the following operation:

Calibrating the video camera equipment with a gyroscope based on Rodrigues' Rotation Matrix and obtaining calibration parameters; then obtaining the first video information and the first gyroscope rotation information, performing stabilization on the first video information according to the calibration parameters and the first gyroscope rotation information and/or removing rolling shutter effect of the first video information according to the calibration parameters and the first gyroscope rotation information.

The steps of “calibrating the video camera equipment with gyroscope based on Rodrigues' Rotation Matrix and obtaining calibration parameter” may be as follows:

(1) obtaining gyroscope rotation angular velocity of the video camera equipment (i.e. the video camera equipment in the mobile terminal); for example, the gyroscope rotation angular velocity may be read out from the gyroscope.

(2) modeling the gyroscope rotation angular velocity with Rodrigues' Rotation Matrix and obtaining a motion model of Rodrigues' Rotation Matrix, for example, this step may be as follows:

Obtaining rotation time corresponding to the gyroscope rotation angular velocity; combining the gyroscope rotation angular velocity and the rotation time, constructing rotation matrix according to the form of Rodrigues' Rotation Matrix and obtaining the motion model of Rodrigues' Rotation Matrix.

(3) obtaining the second video information and the corresponding gyroscope rotation information, in order to facilitate description, in the present disclosure, the gyroscope rotation information corresponding to the second video information is called the second gyroscope rotation information.

For example, the video information may be obtained by shooting video, in order to facilitate description, in this example; the video information obtained during modeling is called the second video information.

(4) calibrating the video camera equipment according to the second video information and the second gyroscope rotation information based on the motion model of Rodrigues' Rotation Matrix and obtaining calibration parameters. For example, the details of this step are as follows:

A. detecting feature points preset in each frame of the second video information, matching feature points between two adjacent frames and obtaining feature matching relationship;

B. switching the second gyroscope rotation information based on the motion model of Rodrigues' Rotation Matrix, and obtaining the corresponding three-dimensional rotation matrix;

C. calibrating the video camera equipment according to the three-dimensional rotation matrix and feature matching relationship, obtaining calibration parameters.

For example, fitting the feature matching relationship according to the preset optimization strategy and obtain the fitted feature matching relationship; calculating the calibration parameters of the video camera equipment with the three-dimensional rotation matrix obtained in step B and the fitted feature matching relationship.

The calibration parameters may include internal parameters of video camera equipment, frame capturing time, and deviation between gyroscope timestamp and frame timestamp of video information.

The steps of performing stabilization on the first video information according to the calibration parameters and the first gyroscope rotation information are as follows:

Making the first gyroscope rotation information smoothed and obtaining accumulated product of the first rotation angular velocity; determining the frame to be processed according to the first video information; obtaining gyroscope rotation angular velocity corresponding to each frame between the first frame of the first video information and the frame to be processed from the first gyroscope rotation information; calculating accumulated product of the second rotation angular velocity according to gyroscope rotation angular velocity corresponding to each frame, wherein the accumulated product of the second rotation angular velocity is accumulated product of the rotation angular velocity from the first frame of the first video information to the frame to be processed; calculating difference between the accumulated product of the second rotation angular velocity and the accumulated product of the first rotation angular velocity and obtaining the first difference; obtaining first global motion matrix according to the first difference and the calibration parameters; re-rendering the first video information according to the first global motion matrix, thus achieving the purpose of stabilization.

The steps of removing the rolling shutter effect of the first video information according to the calibration parameters and the first gyroscope rotation information are as follows:

Determining the frame to be processed according to the first video information; obtaining gyroscope rotation angular velocity corresponding to the frame to be processed from the first gyroscope rotation information; obtaining rotation angular velocity of the first line of the frame to be processed and rotation angular velocity of the Nₜₕ line of the frame to be processed according to gyroscope rotation angular velocity corresponding to the frame to be processed; calculating the difference between the rotation angular velocity of the first line and the rotation angular velocity of the Nₜₕ line and obtaining the second difference; obtaining second global motion matrix according to the second difference and the calibration parameters; re-rendering the first video information according to the second global motion matrix so as to achieve the purpose of removing the rolling shutter effect, wherein N is a positive integer, which may be set according to the needs in the practical application.

The concrete implementation of the operations mentioned above can refer to the examples mentioned before, which is not repeated here.

It may be seen that the mobile terminal in the example of the present disclosure can calibrate the video camera equipment with a gyroscope based on Rodrigues' Rotation Matrix and obtain calibration parameters; then obtain the first video information and the first gyroscope rotation information, perform stabilization on the first video information according to the calibration parameters and the first gyroscope rotation information and/or remove rolling shutter effect of the first video information according to the calibration parameters and the first gyroscope rotation information. This solution uses Rodrigues' Rotation Matrix instead of other rotation matrixes, thus it may be more precise when calculating the calibration parameters, and the computational complexity may be low, that is to say by using this solution, the robustness may be improved, and the computational complexity is low so that the video may be better processed without occupying many computational sources and the video quality may be improved.

Moreover, it's understood for person skilled in the art to accomplish part of or whole steps in the example mentioned above by instructing the related hardware with program. Such program may be stored in a computer-readable storage medium such as read-only memory, random access memory, magnetic or optical disk, etc.

The video processing method, device and system provided in the present disclosure have been described in the above-mentioned description, wherein some examples are used to describe the principle and enforcement modes of the present disclosure, which are helpful for persons skilled in the art to understand the present disclosure, and it is to be understood that the disclosure is not to be limited to the disclosed examples, but on the contrary, is intended to cover various modifications and equivalent arrangements included within the spirit and scope of the disclosure.

What is claimed is:

1. A video processing method, comprising:
calibrating a video camera equipment using a gyroscope based on a Rodrigues' Rotation Matrix to obtain a calibration parameter;
obtaining first video information and first gyroscope rotation information, wherein the first gyroscope rotation information is corresponding to the first video information;
performing at least one of:
stabilizing the first video information according to the calibration parameter and the first gyroscope rotation information; and
removing rolling shutter effect from the first video information according to the calibration parameter and the first gyroscope rotation information.

2. The method of claim 1, wherein the calibrating the video camera equipment comprises:
obtaining a gyroscope rotation angular velocity of the video camera equipment;
modeling the gyroscope rotation angular velocity using the Rodrigues' Rotation Matrix to obtain a motion model of the Rodrigues' Rotation Matrix;
obtaining second video information and second gyroscope rotation information, wherein the second gyroscope rotation information is corresponding to the second video information;
combining the second video information with the second gyroscope rotation information to calibrate the video camera equipment based on the motion model of the Rodrigues' Rotation Matrix to obtain the calibration parameter.

3. The method of claim 2, wherein the combining the second video information and the second gyroscope rotation information comprises:
detecting feature points preset in each frame of the second video information, matching the feature points between two adjacent frames and obtaining a feature matching relationship;
switching the second gyroscope rotation information based on the motion model of the Rodrigues' Rotation Matrix, and obtaining a corresponding three-dimensional rotation matrix; and
calibrating the video camera equipment according to the three-dimensional rotation matrix and the feature matching relationship to obtain the calibration parameter.

4. The method of claim 3, wherein the calibrating the video camera equipment according to the three-dimensional rotation matrix and the feature matching relationship to obtain the calibration parameter comprises:
fitting the feature matching relationship according to a preset optimization strategy to obtain a fitted feature matching relationship;
calculating the calibration parameter of the video camera equipment according to the three-dimensional rotation matrix and the fitted feature matching relationship, wherein the calibration parameter includes: an internal parameter of the video camera equipment, a frame capturing time, and a deviation between a gyroscope timestamp and a frame timestamp of video information.

5. The method of claim 2, wherein the modeling the gyroscope rotation angular velocity using the Rodrigues' Rotation Matrix comprises:
obtaining rotation time corresponding to the gyroscope rotation angular velocity;
combining the gyroscope rotation angular velocity and the rotation time, and constructing a rotation matrix according to the Rodrigues' Rotation Matrix to obtain the motion model of the Rodrigues' Rotation Matrix.

6. The method of any one of claim 1, wherein the stabilizing the first video information according to the calibration parameter and the first gyroscope rotation information further comprises:
performing a smoothing operating on the first gyroscope rotation information to obtain an accumulated product of the first rotation angular velocity;
determining a frame to be processed according to the first video information;
obtaining the gyroscope rotation angular velocity corresponding to each frame between the first frame of the first video information and the frame to be processed from the first gyroscope rotation information;
calculating the accumulated product of the second rotation angular velocity according to the gyroscope rotation angular velocity corresponding to each frame, wherein the accumulated product of the second rotation angular velocity is the accumulated product of the rotation angular velocity from the first frame of the first video information to the frame to be processed;
calculating a difference between the accumulated product of the second rotation angular velocity and the accumulated product of the first rotation angular velocity to obtain a first difference;
obtaining a first global motion matrix according to the first difference and the calibration parameter; and
re-rendering the first video information according to the first global motion matrix.

7. The method of any one of claim 1, wherein the removing the rolling shutter effect comprises:
determining the frame to be processed according to the first video information;
obtaining the gyroscope rotation angular velocity corresponding to the frame to be processed from the first gyroscope rotation information;
obtaining a rotation angular velocity of a first line of the frame to be processed and a rotation angular velocity of a Nₜₕ line of the frame to be processed according to the gyroscope rotation angular velocity corresponding to the frame to be processed;
calculating the difference between the rotation angular velocity of the first line and the rotation angular velocity of the Nₜₕ line to obtain a second difference;
obtaining a second global motion matrix according to the second difference and the calibration parameter; and
re-rendering the first video information according to the second global motion matrix.

8. A video processing device, comprising:
a calibrating unit for calibrating a video camera equipment using a gyroscope based on a Rodrigues' Rotation Matrix to obtain a calibration parameter;
an information obtaining unit for obtaining the first video information and the first gyroscope rotation information, wherein the first gyroscope rotation information is corresponding to the first video information;
a processing unit for performing at least one of:
stabilizing the first video information according to the calibration parameter and the first gyroscope rotation information; and
removing rolling shutter effect from the first video information according to the calibration parameter and the first gyroscope rotation information.

9. The device of claim 8, wherein the calibrating unit comprises an obtaining subunit, a modeling subunit and a calibrating subunit, wherein:
the obtaining subunit is used for obtaining a gyroscope rotation angular velocity of the video camera equipment and obtaining second video information and second gyroscope rotation information, wherein the second gyroscope rotation information is corresponding to the second video information;
the modeling subunit is used for modeling the gyroscope rotation angular velocity using the Rodrigues' Rotation Matrix to obtain a motion model of the Rodrigues' Rotation Matrix;
the calibrating subunit is used for combining the second video information and the second gyroscope rotation information to calibrate the video camera equipment based on the motion model of the Rodrigues' Rotation Matrix to obtain the calibration parameter.

10. The device of claim 9, wherein the calibrating subunit is used for:
detecting feature points preset in each frame of the second video information, matching the feature points between two adjacent frames and obtaining a feature matching relationship;
switching the second gyroscope rotation information based on the motion model of the Rodrigues' Rotation Matrix, and obtaining a corresponding three-dimensional rotation matrix; and
calibrating the video camera equipment according to the three-dimensional rotation matrix and the feature matching relationship to obtain the calibration parameter.

11. The device of claim 10, wherein the calibrating subunit is used for:
fitting the feature matching relationship according to a preset optimization strategy to obtain a fitted feature matching relationship;
calculating the calibration parameter of the video camera equipment according to the three-dimensional rotation matrix and the fitted feature matching relationship, wherein the calibration parameter includes an internal parameter of video camera equipment, a frame capturing time, and a deviation between a gyroscope timestamp and a frame timestamp of video information.

12. The device of claim 9, wherein the modeling subunit is used for:
obtaining rotation time corresponding to the gyroscope rotation angular velocity;
combining the gyroscope rotation angular velocity and the rotation time, and constructing a rotation matrix according to the Rodrigues' Rotation Matrix to obtain the motion model of the Rodrigues' Rotation Matrix.

13. The device of any one of claims 8-12, wherein the processing unit comprises at least one of: a stabilization performing subunit and a correction processing subunit, wherein:
the stabilization performing subunit is used for:
perform a smoothing operation on the first gyroscope rotation information to obtain an accumulated product of the first rotation angular velocity;
determining a frame to be processed according to the first video information;
obtaining the gyroscope rotation angular velocity corresponding to each frame between the first frame of the first video information and the frame to be processed from the first gyroscope rotation information;
calculating the accumulated product of the second rotation angular velocity according to the gyroscope rotation angular velocity corresponding to the each frame, wherein the accumulated product of the second rotation angular velocity is the accumulated product of the rotation angular velocity from the first frame of the first video information to the frame to be processed;
calculating a difference between the accumulated product of the second rotation angular velocity and the accumulated product of the first rotation angular velocity to obtain a first difference;
obtaining a first global motion matrix according to the first difference and the calibration parameter;
re-rendering the first video information according to the first global motion matrix;
the correction processing subunit is used for:
determining the frame to be processed according to the first video information;
obtaining the gyroscope rotation angular velocity corresponding to the frame to be processed from the first gyroscope rotation information;
obtaining a rotation angular velocity of a first line of the frame to be processed and a rotation angular velocity of a Nₜₕ line of the frame to be processed according to the gyroscope rotation angular velocity corresponding to the frame to be processed;
calculating the difference between the rotation angular velocity of the first line and the rotation angular velocity of the Nₜₕ line to obtain a second difference;
obtaining a second global motion matrix according to the second difference and the calibration parameter; and
re-rendering the first video information according to the second global motion matrix.

14. A video processing system, comprising a video processing device having a processor, computer readable medium comprising instructions which, when executed by the processor cause the video processing device to:
calibrate a video camera equipment using a gyroscope based on a Rodrigues' Rotation Matrix to obtain a calibration parameter;
obtain first video information and first gyroscope rotation information, wherein the first gyroscope rotation information is corresponding to the first video information;
perform at least one of steps to:
stabilize the first video information according to the calibration parameter and the first gyroscope rotation information; and
remove rolling shutter effect from the first video information according to the calibration parameter and the first gyroscope rotation information.

15. The video processing system of claim 14, wherein the instructions to calibrate the video camera equipment further comprises instructions to:
obtain a gyroscope rotation angular velocity of the video camera equipment;
model the gyroscope rotation angular velocity using the Rodrigues' Rotation Matrix to obtain a motion model of the Rodrigues' Rotation Matrix;
obtain second video information and second gyroscope rotation information, wherein the second gyroscope rotation information is corresponding to the second video information;
combine the second video information with the second gyroscope rotation information to calibrate the video camera equipment based on the motion model of the Rodrigues' Rotation Matrix to obtain the calibration parameter.

16. The video processing system of claim 15, wherein the instructions to combine the second video information and the second gyroscope rotation information comprises instructions to:
detect feature points preset in each frame of the second video information, match the feature points between two adjacent frames to obtain a feature matching relationship;
switch the second gyroscope rotation information based on the motion model of the Rodrigues' Rotation Matrix, and obtain a corresponding three-dimensional rotation matrix; and
calibrate the video camera equipment according to the three-dimensional rotation matrix and the feature matching relationship to obtain the calibration parameter.

17. The video processing system of claim 16, wherein the instructions to calibrate the video camera equipment according to the three-dimensional rotation matrix comprises instructions to:
fit the feature matching relationship according to a preset optimization strategy to obtain a fitted feature matching relationship;
calculate the calibration parameter of the video camera equipment according to the three-dimensional rotation matrix and the fitted feature matching relationship, wherein the calibration parameter includes: an internal parameter of the video camera equipment, a frame capturing time, and a deviation between a gyroscope timestamp and a frame timestamp of video information.

18. The video processing system of claim 15, wherein the instructions to model the gyroscope rotation angular velocity using the Rodrigues' Rotation Matrix comprises instructions to:
obtain rotation time corresponding to the gyroscope rotation angular velocity;
combine the gyroscope rotation angular velocity and the rotation time, and construct a rotation matrix according to the Rodrigues' Rotation Matrix to obtain the motion model of the Rodrigues' Rotation Matrix.

19. The video processing system of any one of claim 14, wherein the instructions to stabilize the first video information according to the calibration parameter and the first gyroscope rotation information further comprises instructions to:
perform a smoothing operation on the first gyroscope rotation information to obtain an accumulated product of the first rotation angular velocity;
determine a frame to be processed according to the first video information;
obtain the gyroscope rotation angular velocity corresponding to each frame between the first frame of the first video information and the frame to be processed from the first gyroscope rotation information;
calculate the accumulated product of the second rotation angular velocity according to the gyroscope rotation angular velocity corresponding to each frame, wherein the accumulated product of the second rotation angular velocity is the accumulated product of the rotation angular velocity from the first frame of the first video information to the frame to be processed;
calculate a difference between the accumulated product of the second rotation angular velocity and the accumulated product of the first rotation angular velocity to obtain a first difference;
obtain a first global motion matrix according to the first difference and the calibration parameter; and
re-render the first video information according to the first global motion matrix.

20. The video processing system of any one of claim 14, wherein the instructions to remove rolling shutter effect comprises instructions to:
determine the frame to be processed according to the first video information;
obtain the gyroscope rotation angular velocity corresponding to the frame to be processed from the first gyroscope rotation information;
obtain a rotation angular velocity of a first line of the frame to be processed and a rotation angular velocity of a Nₜₕ line of the frame to be processed according to the gyroscope rotation angular velocity corresponding to the frame to be processed;
calculate the difference between the rotation angular velocity of the first line and the rotation angular velocity of the Nₜₕ line to obtain a second difference;
obtain a second global motion matrix according to the second difference and the calibration parameter; and
re-render the first video information according to the second global motion matrix.
